(19) United States
(12) Patent Application Publication
(10) Pub. No.: US 2007/0046961 A1
(43) Pub. Date: Mar. 1, 2007

(54) IMAGE PROCESSING APPARATUS AND METHOD THEREFOR

(75) Inventors: Yoichi Kashibuchi, Tokyo (JP); Shinichi Kato, Kawasaki-shi (JP); Tsutomu Sakaue, Yokohama-shi (JP); Ritsuko Otake, Kawasaki-shi (JP); Yoko Sato, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/466,221

(22) Filed: Aug. 22, 2006

(30) Foreign Application Priority Data
Aug. 23, 2005 (JP) 2005-241559

(51) Int. Cl. G06F 15/00

(52) U.S. Cl. 358/1.9; 358/3.06; 358/3.13

(57) ABSTRACT

A combination to minimize moiré can be determined theoretically or empirically in four-color printing, but it is very difficult to find a combination to minimize moiré in printing using five or more colors. To solve this problem, image data is color-separated into image data corresponding to plural colorant. Multilevel dither processing is performed to the image data corresponding to the plural colorant. At this time, dither matrices having the same screen angle, the same screen ruling, and different threshold setting methods are applied to the respective image data corresponding to dark colorant and light colorant having the same hue and different lightness values.

### BACKGROUND OF THE INVENTION

1. Field of the Invention

The present invention relates to image processing to perform multilevel dither processing for image data corresponding to colorant.

2. Description of the Related Art

An electrophotographic image printing apparatus irradiates an image carrier with light such as a laser beam and prints an image in accordance with the amount of irradiation. The apparatus can form any image including a binary image such as a text and a halftone image such as a photo. In order to reproduce halftone density, pulse width modulation (PWM) or digital halftoning such as dithering and density patterning is used. Charged toners (colorant or color materials) are attached to a pattern on the image carrier and transferred and fixed on a printing sheet, thereby obtaining a final output image. Generally, four toners of cyan (C), magenta (M), yellow (Y), and black (K) are used. In order to reduce graininess, improve tone reproduction, and improve image quality such as density, saturation, gloss, and the like, various modifications have been introduced.

Along with the recent progress of digital technology, the demand has arisen for high-quality images by the image printing apparatus from a print-on-demand (POD) market to a consumer market in offices, homes, and the like. That is, not only screen-processed images but also photo images demand image characteristics having high tone reproduction, wide gamut, and reduced graininess.

A multi-color printing which uses the above-described four color toners as dark colorant and toners of light colorant having the same or similar hue as those of the dark colorant and low lightness has been considered. A method of using four or more toners including red (R), green (G), and blue (B) respectively serving as complementary colors of cyan (C), magenta (M), and yellow (Y), gold and silver serving as spot colors, and a transparent color is also available. By using these five or more colorant, image characteristics improve as compared to a case wherein four colorant are used.

Using five or more colorant requires increases in the number of developing stations and the number of colors to be drawn on the image carrier. Accordingly, when dithering as a representative digital halftoning is used, the degree of freedom of screen angle decreases, and image failures caused by interference fringes called moiré or rosetta patterns (or rosetta marks) are readily generated. In other words, a combination to minimize moiré can be determined theoretically or empirically in four-color printing, but it is very difficult to find a combination to minimize moiré in printing using five or more colors.

In order to solve this problem, Japanese Patent Laid-Open No. 2005-045348 discloses digital halftoning which uses the same dither pattern for dark and light colors having the same hue.

However, as a technique disclosed in Japanese Patent Laid-Open No. 2005-045348 uses the same dither pattern to prevent image failures caused by moiré or rosetta patterns, it is weak against misregistration. When color misregistration occurs, the density changes and color reproduction decreases.

In Japanese Patent Laid-Open No. 2-031561, dithering is used for dark colors and FM-screen digital halftoning (e.g., error diffusion) is used for light and spot colors. That is, a technique is disclosed which combines several types of digital halftoning to prevent moiré when using five or more colors. However, noise unique to the FM-screen system may occur in the light or spot colors, and a preferable printing result may not be obtained.

Furthermore, an image forming method using dithering with less image failures caused by moiré or rosetta marks is demanded in four-color printing as well.

### SUMMARY OF THE INVENTION

The first aspect of the present invention discloses an image processing apparatus comprising: a color separator, arranged to color-separate input image data into image data corresponding to plural colorant; and a halftone processor, arranged to perform multilevel dither processing for the image data corresponding to the plural colorant, wherein the halftone processor applies dither matrices having the same screen angle, the same screen ruling, and different threshold setting methods to respective image data corresponding to dark colorant and light colorant having the same or similar hue and different lightness values.

The second aspect of the present invention discloses an image processing apparatus comprising: a color separator, arranged to color-separate input image data into image data corresponding to plural colorant; and a halftone processor, arranged to perform multilevel dither processing for the image data corresponding to the plural colorant, wherein the halftone processor applies, to image data corresponding to yellow colorant, a dither matrix having the same screen angle and the same screen ruling as those of remaining colorant and a different threshold setting method from those of the remaining colorant.

The third aspect of the present invention discloses an image processing apparatus comprising: a color separator, arranged to color-separate input image data into image data corresponding to plural colorant; and a halftone processor, arranged to perform multilevel dither processing for the image data corresponding to the plural colorant, wherein the halftone processor applies dither matrices having the same screen angle and the same screen ruling and different threshold setting methods to image data corresponding to respective complementary colorant.

According to the present invention, in a printing system using five or more colors including dark and light color toners having the same or similar hue, generation of moiré and interference fringes can be reduced.

In addition, noise unique to an FM-screen system can be prevented.

Furthermore, in a four-color printing system, generation of moiré and rosetta patterns can be reduced by using dithering.

Further features of the present invention will become apparent from the following description of exemplary embodiments with reference to the attached drawings.

### BRIEF DESCRIPTION OF THE DRAWINGS

FIG. 1 is a schematic view showing a full-color image forming apparatus according to an embodiment;

FIG. 2 is a block diagram showing the configuration of a controller which controls the image forming apparatus shown in FIG. 1;

FIG. 3 is a block diagram showing the configuration of an image processing unit;

FIG. 4 is a view for explaining multilevel dithering;

FIG. 5 is a view for explaining a design method for a screen angle and dither matrix;

FIG. 6 shows views illustrating screen angles and the screen ruling of respective colors;

FIG. 7 is a view for explaining a dither matrix of a “general” screen and “flat” screen;

FIGS. 8A to 8C are views showing an example of a dither matrix for cyan;

FIGS. 9A to 9C are views showing an example of a dither matrix for light cyan;

FIGS. 10A to 10C are views showing an example of a dither matrix for magenta;

FIGS. 11A to 11C are views showing an example of a dither matrix for light magenta;

FIG. 12 shows views illustrating an example of a dither matrix for yellow;

FIG. 13 shows views illustrating an example of a dither matrix for black;

FIG. 14 is a block diagram showing the configuration of an image processing unit of an image forming apparatus according to the second embodiment;

FIG. 15 shows views showing an example of a dither matrix for yellow according to the second embodiment; and

FIG. 16 is a block diagram showing the configuration of an image processing unit of an image forming apparatus according to the third embodiment.

### DESCRIPTION OF THE EMBODIMENTS

Image processing according to preferred embodiments of the present invention will be described in detail below with reference to the accompanying drawings.

### First Embodiment

[Configuration of Image Forming Apparatus]

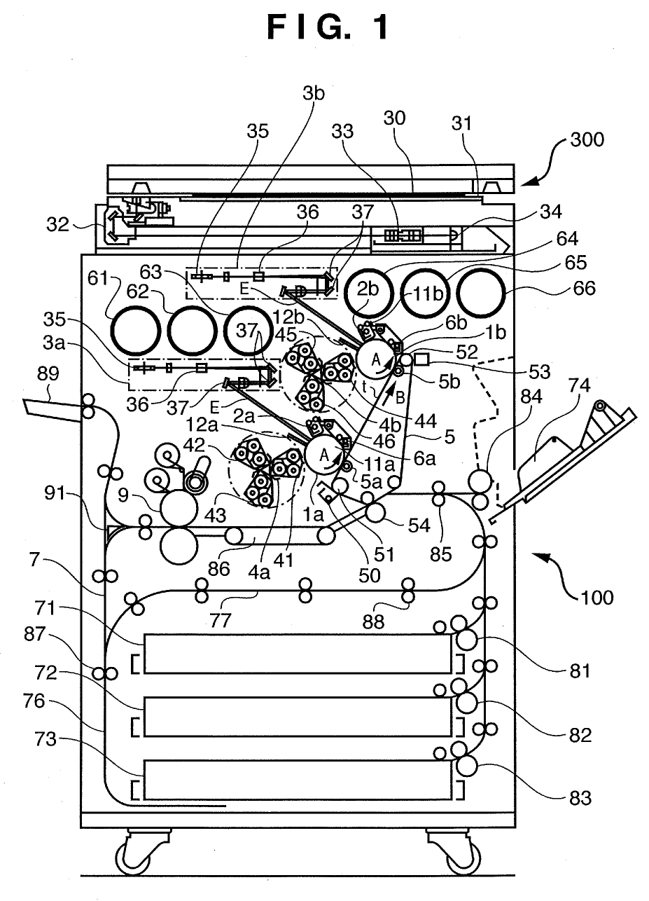

FIG. 1 is a schematic view showing a full-color image forming apparatus (to be referred to as an “image forming apparatus” hereinafter) according to the embodiment.

The image forming apparatus has a reader 300 as the upper part and a printer 100 as the lower part. Note that the image forming apparatus may be a multi-functional peripheral equipment having not only a copying function but also a printer function and/or a facsimile function.

The reader 300 exposes a document 30 set on a glass document table 31 with light from the lamp of a scanner unit 32, and moves the scanner unit 32 in the sub-scanning direction. Light reflected by the document 30 converges on a CCD sensor 34 via the mirror of the scanner unit 32 and a lens 33. Color-separated image signals output from the CCD sensor 34 are amplified by an amplifier circuit (not shown), and converted into R, G, and B image data by a video processing unit (not shown). The R, G, and B image data are stored in an image memory (not shown), and then output to the printer 100.

Note that the printer 100 receives image data output from the reader 300, also receives image data from a computer via a network, and receives a facsimile image signal via a telephone line. The operation of the printer 100 for image data output from the reader 300 will be described below.

The printer 100 has roughly two image forming sections: the first image forming section including a photosensitive drum 1a, and the second image forming section including a photosensitive drum 1b. These image forming sections have almost the same configuration (shape) for the purpose of cost reduction. That is, developing units 41 to 46 (to be described later) also have almost the same configuration and shape, and the printer 100 can operate even if the developing units 41 to 46 are exchanged.

The two photosensitive drums 1a and 1b serving as image carriers are held rotatably in directions indicated by arrows A shown in FIG. 1. The photosensitive drums 1a and 1b are surrounded with the following building components. The exposure system is made up of pre-exposure lamps 11a and 11b, corona chargers 2a and 2b, exposure portions 3a and 3b of the optical system, and potential sensors 12a and 12b. The developing system is made up of moving members (developing rotaries) 4a and 4b serving as holding portions for rotary developing units, three developing units 41 to 43 and three developing units 44 to 46 which store developing materials of different colors in the corresponding holding portions, primary transfer rollers 5a and 5b, and cleaning units 6a and 6b.

For higher image quality, the number of developing units suffices to be five or more, and the first embodiment uses the six developing units 41 to 46. Toners stored in the respective developing units are as follows:

magenta toner in the developing unit 41;

cyan toner in the developing unit 42;

light magenta toner in the developing unit 43;

yellow toner in the developing unit 44;

black toner in the developing unit 45; and

light cyan toner in the developing unit 46.

The developing materials (colorant) of dark and light colors are prepared by adjusting the amounts of pigments having the same spectral characteristic. More specifically, light magenta toner contains a pigment, which has the same spectral characteristic as that of magenta toner, but has a smaller pigment content. Similarly, light cyan toner contains a pigment, which has the same spectral characteristic as that of cyan toner, but has a smaller pigment content. In place of the light color toners, developing units storing spot color toners such as red and green may be used.

In addition, the developing rotaries 4a and 4b can also have developing units (identical in shape to the above-mentioned developing units) which store toners (e.g., metallic toners such as gold and silver, and a fluorescent color toner including a fluorescent material) different in pigment spectral characteristic from cyan, magenta, yellow, and black.

Each developing unit stores a two-component developing material using a mixture of toner and carrier, but even a one-component developing material formed from only toner can be adopted without any problem.

The use of dark and light colors of magenta and cyan aims to dramatically improve the reproducibility of a light-color image of, e.g., human skin, in other words, to reduce the graininess of a light-color area.

In forming an image, the photosensitive drums 1a and 1b rotate in the directions indicated by the arrows A, are discharged by the pre-exposure lamps 11a and 11b, and uniformly charged on the surfaces by the chargers 2a and 2b. The exposure portions 3a and 3b convert image data input from the reader 300 into optical signals by laser output portions (not shown). The optical signals (laser beams E) are reflected by polygon mirrors 35 to irradiate exposure positions on the surfaces of the photosensitive drums 1a and 1b via lenses 36 and reflecting mirrors 37. As a result, electrostatic latent images are formed for each toner color (separated color) on the photosensitive drums 1a and 1b.

Then, the developing rotaries 4a and 4b are rotated to move the developing units 41 and 44 to developing positions on the photosensitive drums 1a and 1b. The developing units 41 and 44 are operated (the developing bias is applied to the developing units 41 and 44) to develop the electrostatic latent images on the photosensitive drums 1a and 1b. Images of developing materials (toner images) containing a resin and pigment as a substrate are formed on the photosensitive drums 1a and 1b. The electrostatic latent images are developed by the developing units 42 and 45 in the next developing and by the developing units 43 and 46 in the second next developing.

Note that the developing units 41 to 46 are refilled with toners at predetermined timings on occasion from toner storage portions (hoppers) 61 to 66 for the respective colors which are arranged between the exposure portions 3a and 3b or beside the exposure portion 3b, so as to keep the toner ratio (or toner amount) in each developing unit constant.

Toner images formed on the photosensitive drums 1a and 1b are sequentially transferred by the primary transfer rollers 5a and 5b onto an intermediate transfer member (intermediate transfer belt) 5 serving as a transfer medium, so that they are superposed on each other. At this time, the primary transfer bias is applied to the primary transfer rollers 5a and 5b.

The photosensitive drums 1a and 1b are arranged in contact with a flat surface (transfer surface t) formed by the intermediate transfer belt 5 which is looped between a driving roller 51 and a driven roller 52 and driven in a direction indicated by an arrow B shown in FIG. 1. The primary transfer rollers 5a and 5b are arranged at positions facing the photosensitive drums 1a and 1b.

A sensor 53 which detects positional errors and the densities of images transferred from the photosensitive drums 1a and 1b is arranged at a position facing the driven roller 52. Control to correct the image density of the image forming section, the toner refill amount, the image write timing, the image write start position, and the like is performed at any time on the basis of information obtained by the sensor 53.

After the above-described formation, developing, and primary transfer of electrostatic latent images are repeated three times in the two image forming sections, a full-color toner image of sequentially superposed toner images of the six colors is formed on the intermediate transfer belt 5. The full-color toner image on the intermediate transfer belt 5 is secondarily transferred at once on a print sheet. At this time, the secondary transfer bias is applied to a secondary transfer roller 54.

A transfer cleaning device 50 is arranged at a position facing the driving roller 51. The transfer cleaning device 50 removes toner left on the intermediate transfer belt 5 after the end of secondary transfer. The driving roller 51 pushes the intermediate transfer belt 5 toward the transfer cleaning device 50 to bring the intermediate transfer belt 5 into contact with the transfer cleaning device 50 and clean the intermediate transfer belt 5. After the end of cleaning, the intermediate transfer belt 5 moves apart from the transfer cleaning device 50. The cleaned intermediate transfer belt 5 prepares for the next image formation.

Print sheets are conveyed one by one to the image forming section from a print sheet cassette 71, 72, or 73 or a manual feed tray 74 by a pickup roller 81, 82, 83, or 84. A skew is corrected by registration rollers 85, and a print sheet is supplied to the secondary transfer position in synchronism with the sheet feed timing.

A print sheet on which a full-color toner image is transferred is conveyed by a convey belt 86, and the toner image is fixed by a heat roller fixing unit 9. Thereafter, the print sheet is discharged onto a delivery tray 89 or a post-processing apparatus (not shown).

When images are formed on the two surfaces of a print sheet, a convey path switching guide 91 is driven to guide a print sheet having passed through the heat roller fixing unit 9 to a reverse path 76 via a vertical convey path 7. Then, a reverse roller 87 is rotated in the opposite direction to set the trailing end of the print sheet guided to the reverse path 76 as the leading end. The print sheet is withdrawn from the reverse path 76 and guided to a double-sided convey path 77. The print sheet passes through the double-sided convey path 77, and sent to the registration rollers 85 by double-sided convey rollers 88. A full-color image is formed on the other surface of the print sheet by the above-described image forming process.

[Controller]

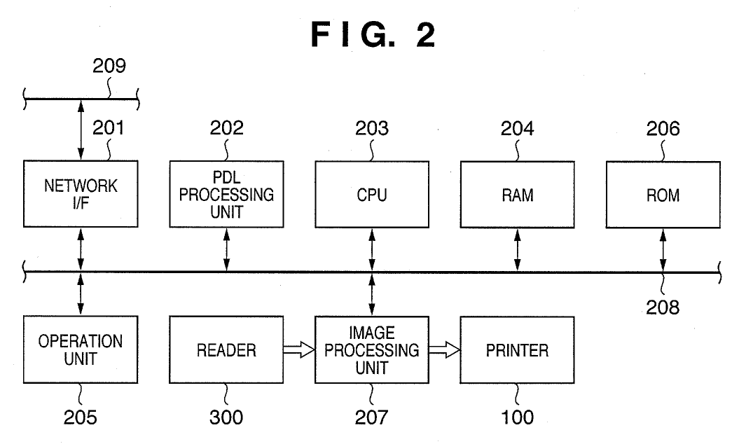

FIG. 2 is a block diagram showing the configuration of a controller which controls the image forming apparatus shown in FIG. 1.

A CPU 203 of the controller uses a RAM 204 as a work memory, and executes programs stored in a ROM 206 to control building components (to be described below) via a system bus 208.

An operation unit 205 receives an instruction from the user, notifies the CPU 203 of it, and displays the apparatus state or the like under the control of the CPU 203. When the user designates a job containing read of an image such as copying of an image via the operation unit 205, the CPU 203 controls the reader 300 to input image data obtained by reading a document image to an image processing unit 207.

The image processing unit 207 performs image processing corresponding to the job for the received image data. For example, for a copy job, the image processing unit 207 performs image processing suitable for a printer output for image data input from the reader 300, and outputs the processed image data to the printer 100.

Although not shown in FIG. 2, the system bus 208, reader 300, and printer 100 are connected to each other via a predetermined interface. The CPU 203 can acquire status information representing the operation states of the reader 300 and printer 100 to control their operations.

A network interface (I/F) 201 is connected to a network 209 such as a local area network (LAN), communicates with a computer and server connected to the network 209, and exchanges various commands and data. For example, when a print job containing image data (to be referred to as “PDL data” hereinafter) described in a description language such as a page description language is received from an external computer, the CPU 203 supplies the PDL data to a PDL processing unit 202. The PDL processing unit 202 transfers, to the image processing unit 207, image data rendered by interpreting the PDL data. The image processing unit 207 performs image processing appropriate for a printer output for the input image data, and outputs the processed image data to the printer 100. Accordingly, the print job is executed.

When a scan job is received from an external computer, the CPU 203 causes the reader 300 to read an image. The CPU 203 causes the image processing unit 207 to generate image data corresponding to the read image, and transmits the image data via the network I/F 201 to the destination such as the computer which has issued the scan job. Note that the image data is generated in a data format designated by the scan job.

The controller further incorporates a facsimile transmission/reception unit, an interface with a telephone line, and the like, but a description of them will be omitted.

[Image Processing Unit]

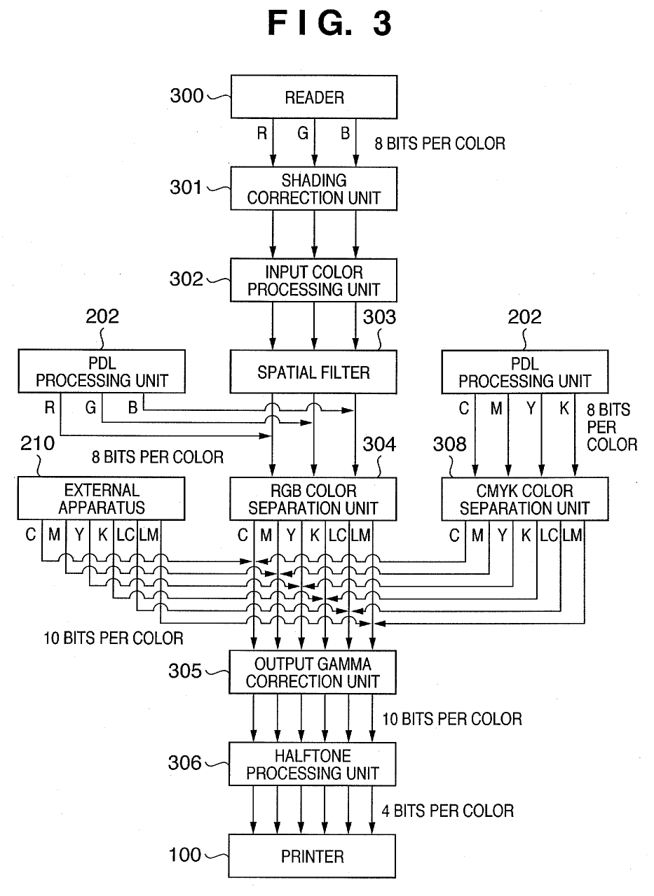

FIG. 3 is a block diagram showing the configuration of the image processing unit 207.

In many cases, image data output from the reader 300 is RGB image data of 8 bits (256 tone levels) per pixel. In the image processing unit 207, input RGB image data undergoes white level correction by a shading correction unit 301, and input masking processing by an input color processing unit 302. These processes remove color grayness and the like generated by the spectral characteristic of the CCD. Further, the frequency characteristic of the input image data is corrected by a spatial filter 303.

In the image processing unit 207, RGB image data obtained by the above processing or RGB image data (8 bits for each color) generated by the PDL processing unit 202 is input into an RGB color separation unit 304. In the RGB color separation unit 304, RGB image data is separated into six color signals of C, N, Y, K, LC (light cyan), and LM (light magenta) (10 bits for each color) by direct mapping. The PDL processing unit 202 sometimes outputs CMYK image data (8 bits for each color). In this case, CMYK image data is color-separated into six colors of C, X, Y, K, LC, and LM signals (10 bits for each color) by direct mapping in a CMYK color separation unit 308. C, N, Y, K, LC, and LM signals are sometimes input directly from an external computer (external apparatus 210).

In the image processing unit 207, six color signals are input into an output gamma correction unit 305. The output gamma correction unit 305 corrects (gamma correction) the output characteristic of each color-separated signal by using a one-dimensional lookup table (1DLUT) independent for each color.

A halftone processing unit 306 performs, for the color-separated signal, digital halftoning (multilevel dithering) corresponding to the number of tones and the resolution which can be reproduced by the printer 100. The image processing unit 207 outputs the C, M, Y, and K signals or C, X, Y, K, LC, and LM signals having undergone the digital halftoning to the printer 100. Note that the number of tones and the resolution of the printer 100 are, e.g., 4 bits and 600 dpi, but are not limited to them. Digital halftoning uses well-known screen ruling or error diffusion.

[Multilevel Dithering]

Multilevel dithering to be preformed by the halftone processing unit 306 will be described next.

Multilevel dithering is a digital halftoning method performed by extending binary dithering into multilevel dithering. Multilevel dithering has a plurality of thresholds for each dither matrix cell, and each processed pixel can take a plurality of values. Naturally, multilevel dithering requires so-called multitone printing which can print three or more tones per pixel. The electrophotographic method implements multitone printing by PWM.

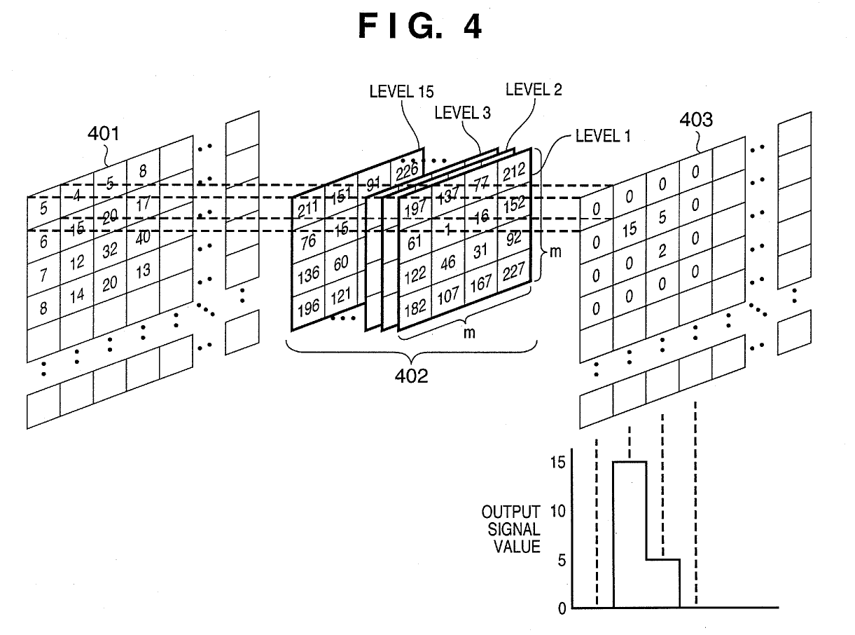

FIG. 4 is a view for explaining multilevel dithering.

The halftone processing unit 306 uses a dither matrix 402 which is designed such that processing-result of each color has an arbitrary screen angle and an arbitrary screen ruling. The dither matrix 402 has a plurality of levels of threshold matrices corresponding to the number of tones of an output signal from the halftone processing unit 306. As the halftone processing unit 306 of this embodiment outputs a 4-bit signal, the dither matrix 402 has 15 threshold matrices corresponding to levels 1 to 15 of the output signal.

The halftone processing unit 306 selects a cell to be referred from the dither matrix 402 in accordance with input pixel coordinates of input image data 401, and compares the input pixel value with thresholds of corresponding 15 cells. More specifically, the input pixel value is compared with the thresholds of the 15 cells and, of the threshold matrices having the cells whose thresholds are equal to or smaller than the input pixel value, a threshold matrix having a highest level number is set as an output signal value. When the pixel value is smaller than any thresholds of the 15 cells, the output signal value is set 0, and output image data 403 is output.

A design method for a screen angle and dither matrix will be described next.

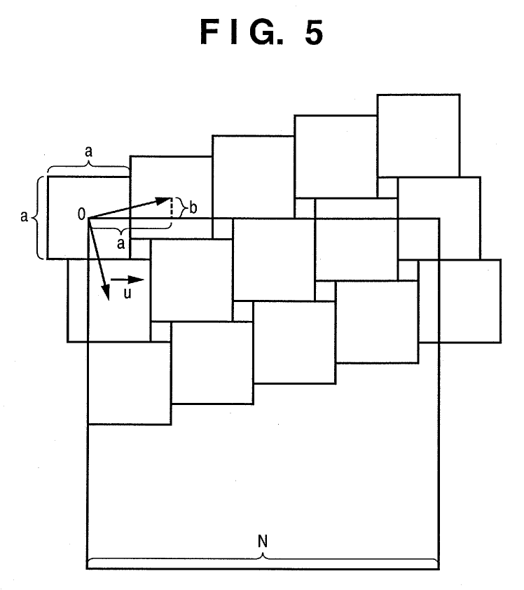

A dither matrix for each color is formed in the following manner. As shown in FIG. 5, basic dots (basic cells) of a×a pixels are appropriately shifted and positioned to form dots having a predetermined screen angle and a predetermined screen ruling. When a shift value (displacement vector) is set u=(a,b), a screen angle θ and the screen ruling LPI (lines per inch) to be obtained can be expressed by:
θ=tan⁻¹(b/a)
LPI=DPI/√(a²+b²)
where DPI is the output resolution.

A size N of a square threshold matrix corresponding to one dot cycle is expressed as follows by using the displacement vector u:
N=LCM(a, b)×(b/a+a/b)
where LCM(a, b) is the least common multiple of a and b.

In order to implement a dither matrix having a desired screen angle and a desired screen ruling and to reduce the load of hardware, it is required to use a smallest matrix size N.

Setting different screen angles for respective colors has the following effect. That is, even when the position of each color shifted, color uniformity can be maintained, generation of moiré fringes can be prevented, and so on. Particularly, generation of moiré fringes strongly depends on the combination of the screen angles of the respective colors. A widely prevalent combination of screen angles is, e.g., 0° for yellow, 15° for cyan (or magenta), 45° for black, and 75° for magenta (or cyan).

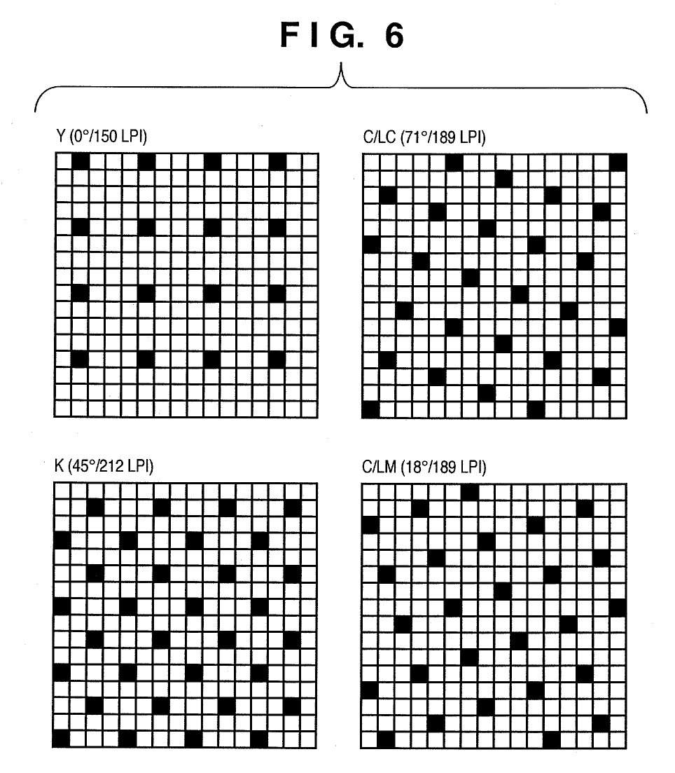

FIG. 6 shows views showing the screen angles and the screen ruling of respective colors. The screen angles and the screen ruling of respective colors are set as follows:

71° and 189 for cyan and light cyan;

18° and 189 for magenta and light magenta;

0° and 150 for yellow; and

45° and 212 for black.

For cyan, magenta, yellow, and black, a generally used matrix (to be referred to as “normal” screen hereinafter) which grows dots in a direction to increase the tone value is used. For light cyan and light magenta as light colors, a matrix (to be referred to as “flat” screen hereinafter) which grows dots in a direction to increase the dot area in the matrix is used.

The “normal” screen and “flat” screen will be described next.

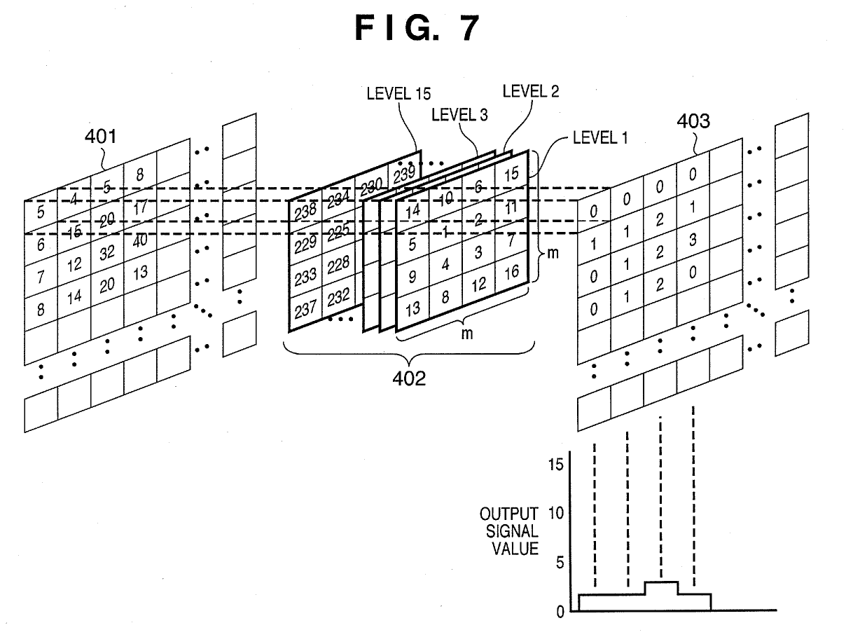

FIGS. 4 and 7 respectively show a dither matrix of a “normal” screen and that of a “flat” screen having the same screen angle and the same screen ruling. Note that the input image data 401 is the same in FIGS. 4 and 7.

In the “normal” screen shown in FIG. 4, thresholds are set so as to increase a cell value between cells at identical matrix positions in threshold matrices having different levels along with an increase in levels (to be referred to as “grow in the level direction” hereinafter). After making the threshold of a given cell grown in the level direction, the threshold of a cell adjacent to the given cell is grown in the level direction. Accordingly, like an output signal value corresponding to the second column of the dither matrix 402 shown in a graph at the lower right of FIG. 4, the output signal value shows a tendency to concentrate dots in a basic cell (form high-density dots in a small area). A pattern appears strongly at basic cell cycle. Such a threshold setting method is sometimes called as a “threshold growing method”.

On the other hand, in the “flat” screen shown in FIG. 7, thresholds are set so as to increase the dot area in the dither matrix 402. As in the “normal” screen, the threshold is grown in the level direction between cells at identical positions in threshold matrices having different levels. After making the threshold of a given cell grown in the level direction, the threshold of an adjacent cell adjacent to the given cell is grown in the level direction, and then the threshold of a cell adjacent to the adjacent cell is grown in the level direction. Accordingly, as an output signal value corresponding to the second column of the dither matrix 402 shown in a graph at the lower right of FIG. 7, the output signal value shows a tendency to diffuse the dots in the basic cell (form low-density dots in a large area) That is, the pattern at basic cell cycle rarely appears as compared to the “normal” screen.

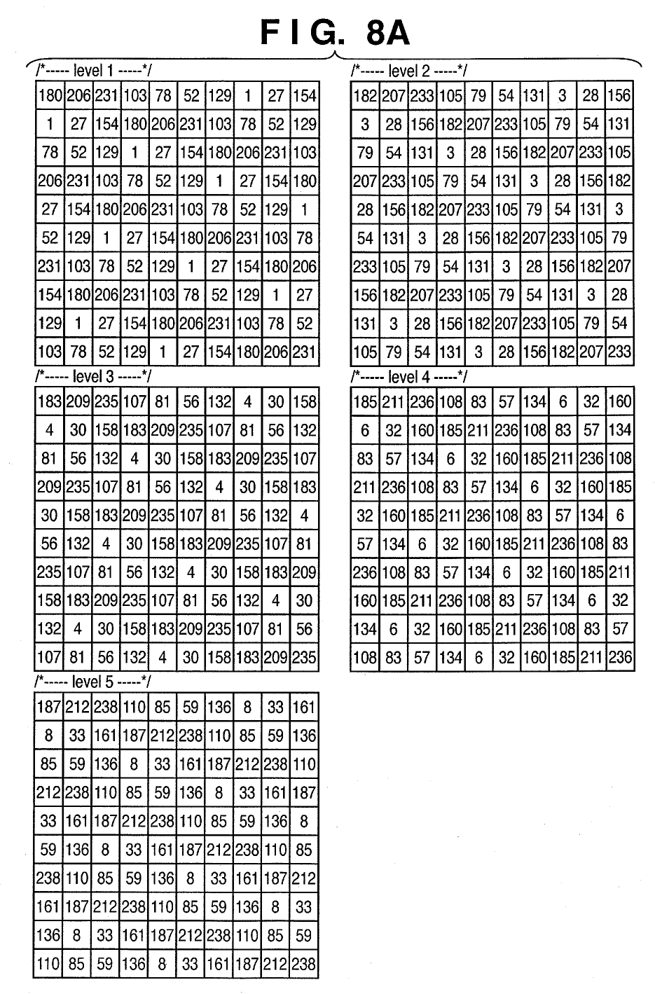

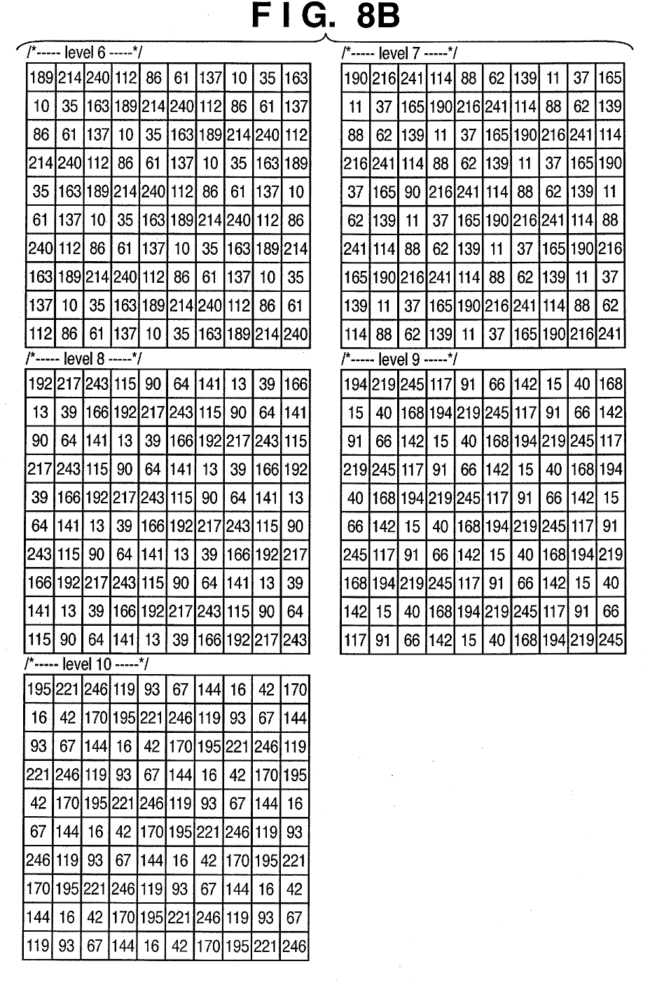

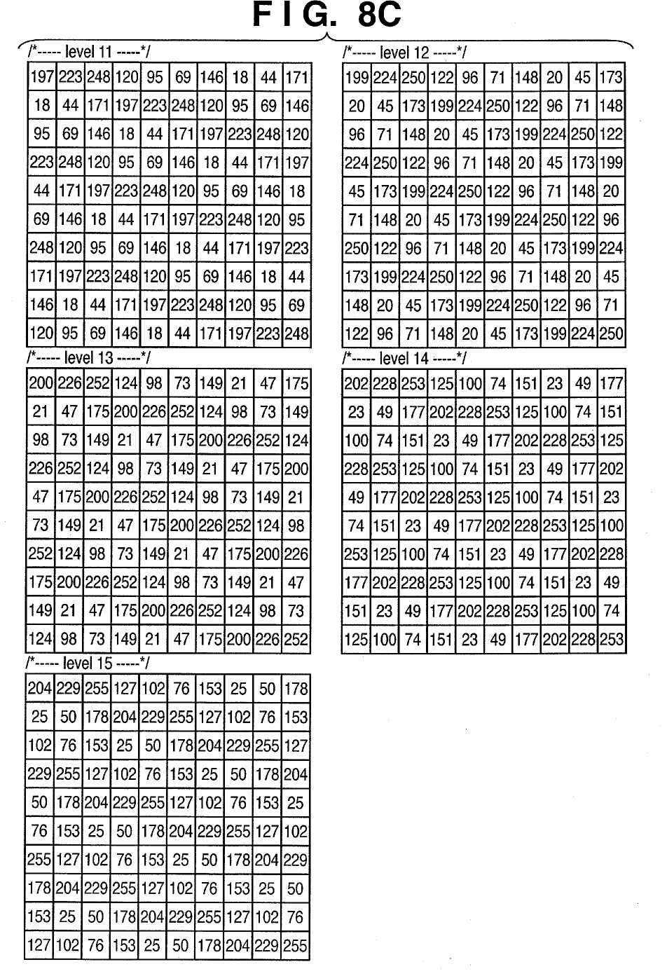

FIGS. 8A to 8C are views showing an example of a dither matrix of a “normal” screen having a screen angle of 71° and the screen ruling of 189 LPI, which is a dither matrix for cyan.

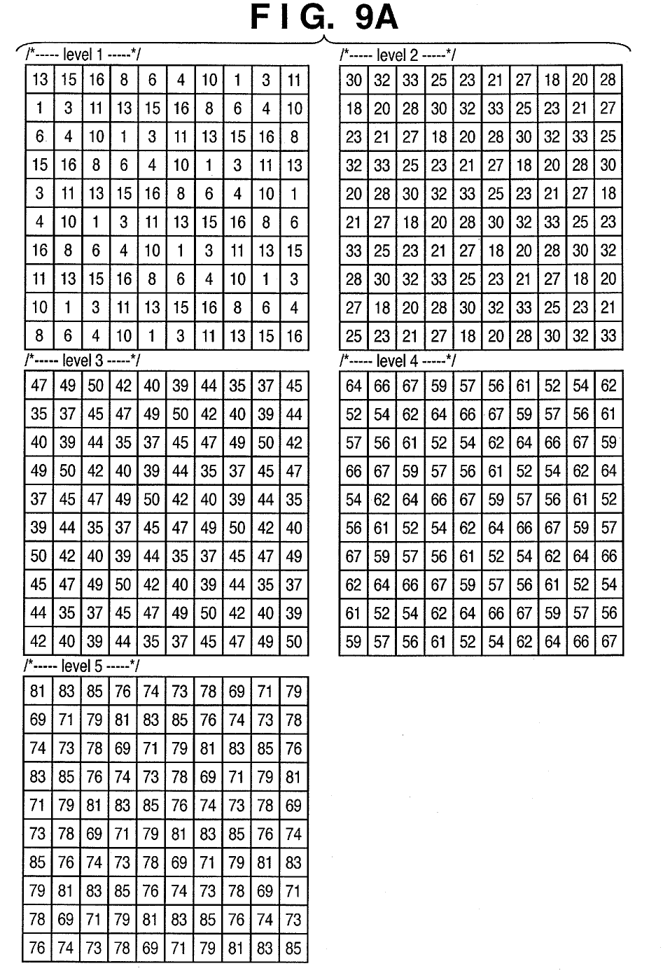

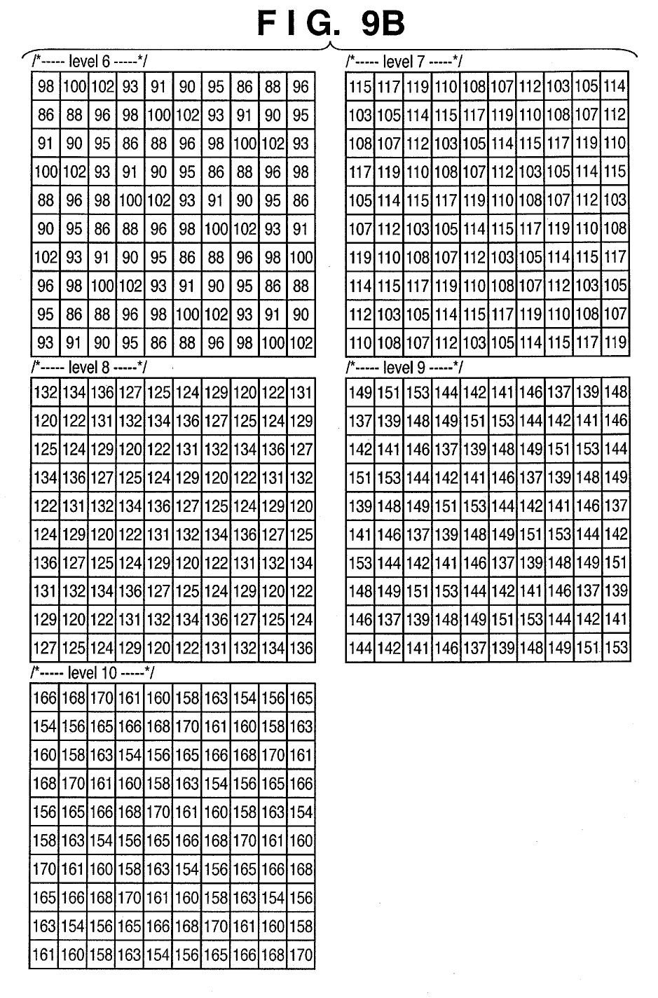

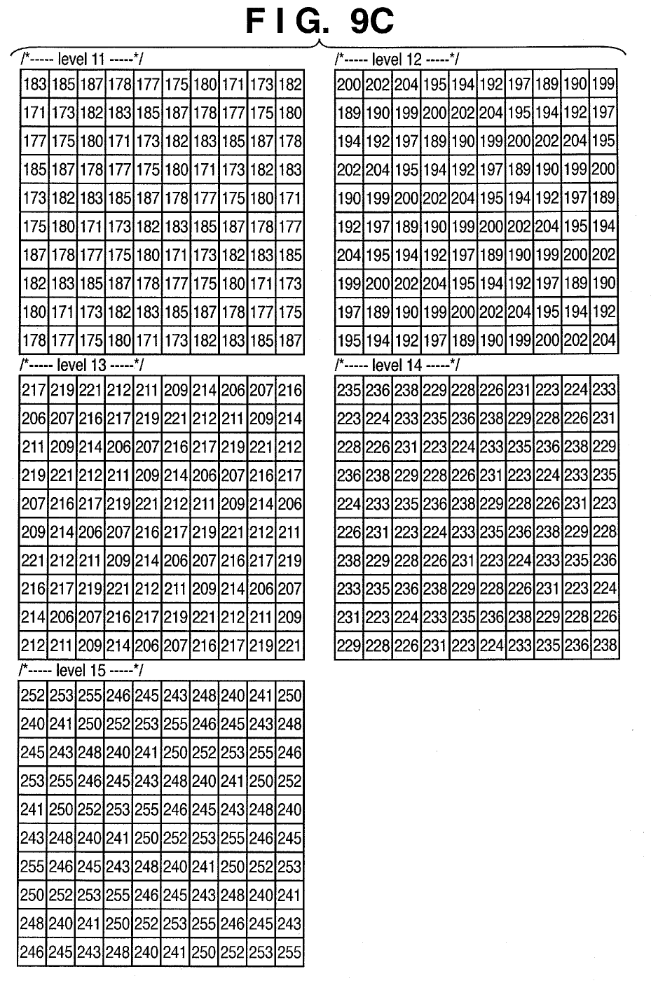

FIGS. 9A to 9C are views showing an example of a dither matrix of a “flat” screen having a screen angle of 71° and the screen ruling of 189 LPI, which is a dither matrix for light cyan.

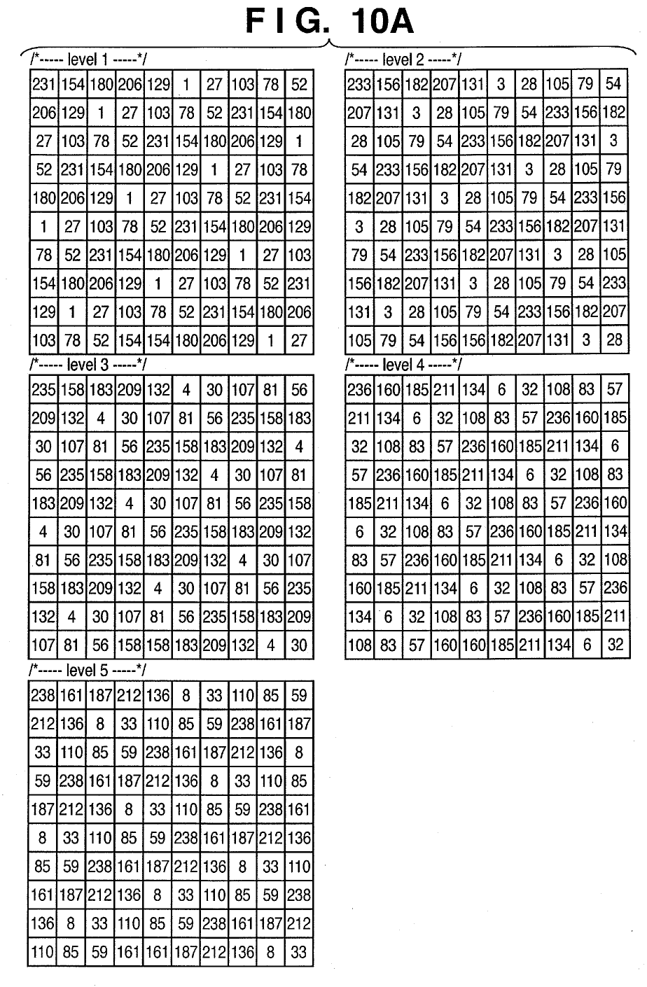

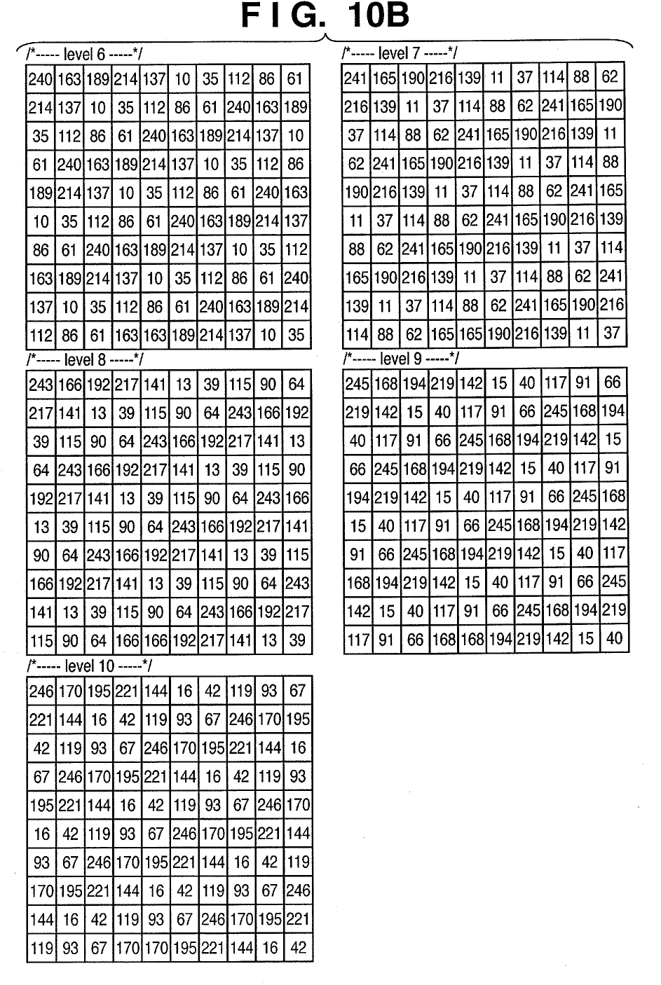

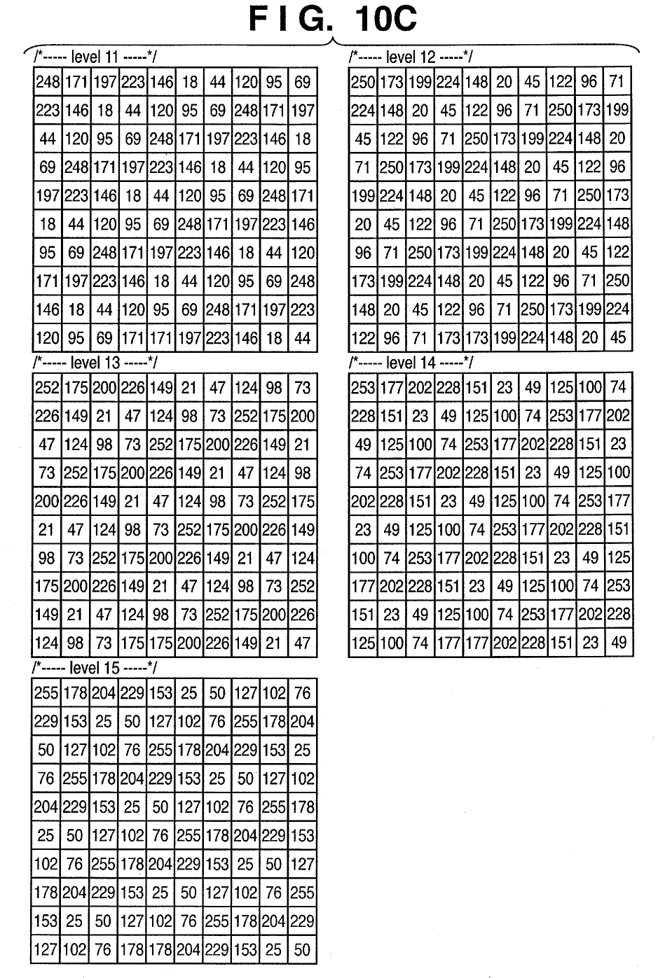

FIGS. 10A to 10C are views showing an example of a dither matrix of a “normal” screen having a screen angle of 18° and the screen ruling of 189 LPI, which is a dither matrix for magenta.

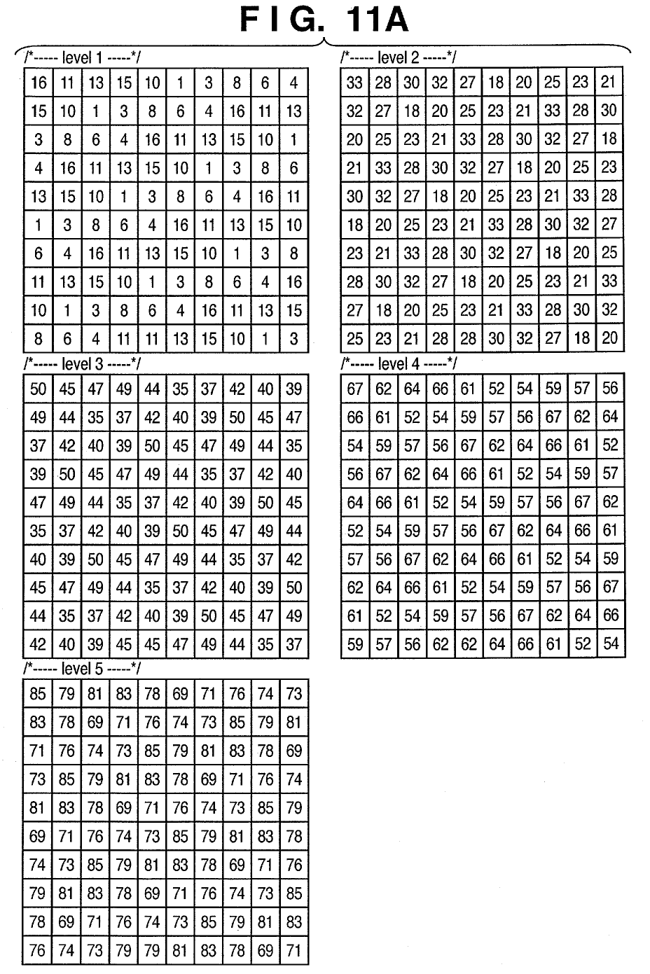

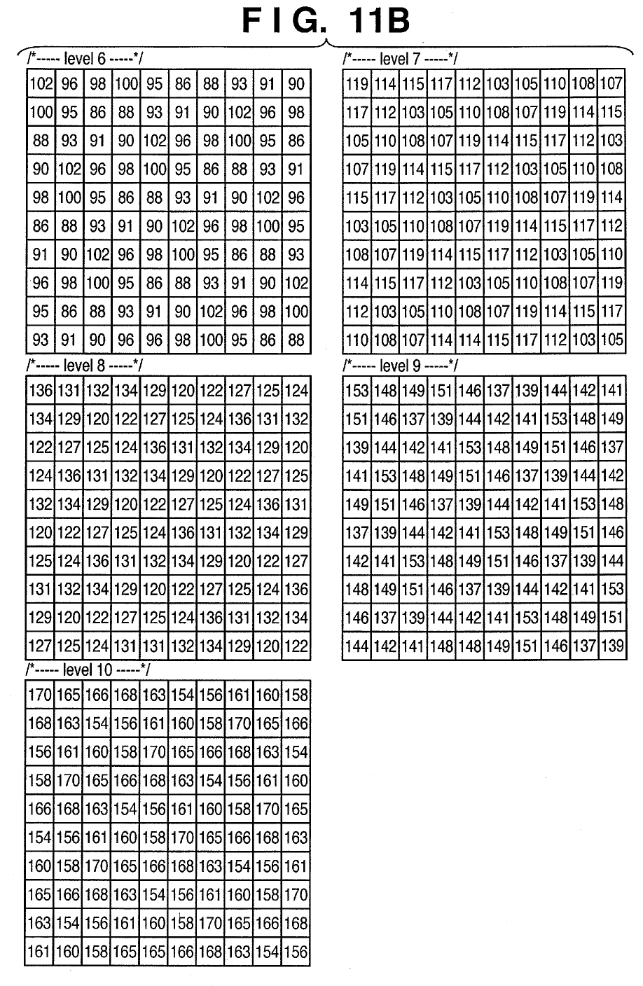

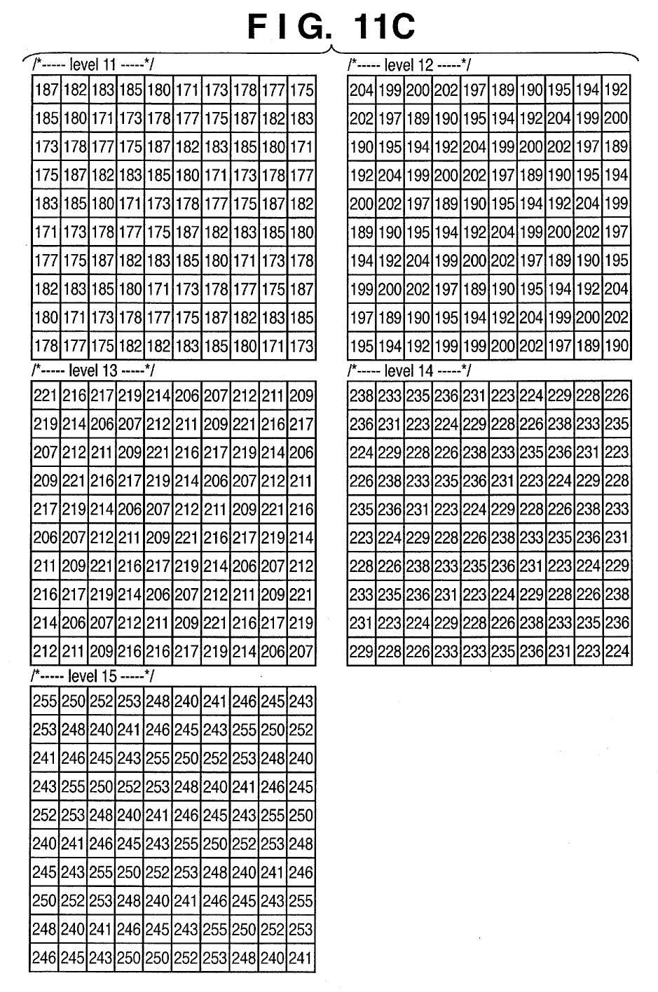

FIGS. 11A to 11C are views showing an example of a dither matrix of a “flat” screen having a screen angle of 18° and the screen ruling of 189 LPI, which is a dither matrix for light magenta.

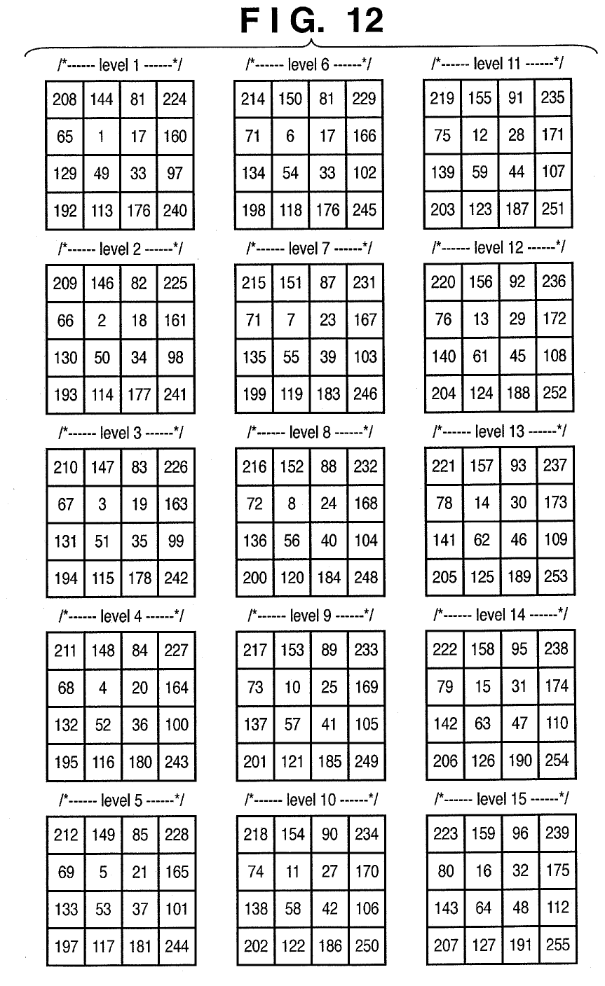

FIG. 12 is a view showing an example of a dither matrix of a “normal” screen having a screen angle of 0° and the screen ruling of 150 LPI, which is a dither matrix for yellow.

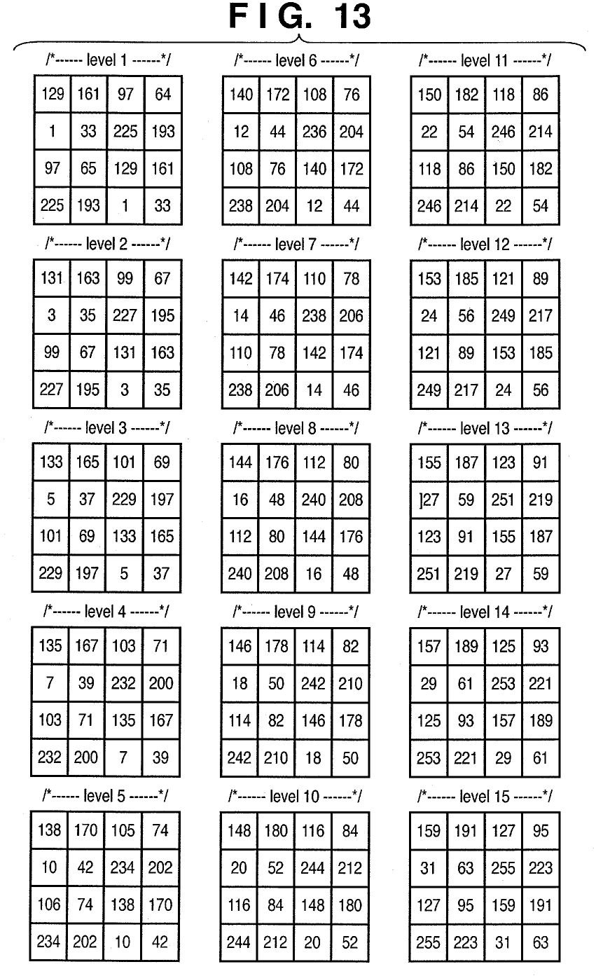

FIG. 13 is a view showing an example of a dither matrix of a “normal” screen having a screen angle of 45° and the screen ruling of 212 LPI, which is a dither matrix for black.

Values are filled in all threshold matrices of the above-described “flat” screens in ascending order of the threshold from the threshold matrix of level 1 and then subsequent matrices in the level growing direction. That is, with respect to solid input image data 401 with no tone change, each matrix is designed to always have a level difference between the maximum and minimum values of output image data 403 equal to or less than 1. With this arrangement, the pattern at basic cell cycle hardly appears. Even if a dither matrix which has a level difference equal to or more than 2 is designed for solid input image data 401, the dither matrix can be used as long as the thresholds of the whole threshold matrix grow.

### Second Embodiment

Image processing according to the second embodiment of the present invention will be described below. Note that, in the second embodiment, the same arrangements as in the first embodiment are denoted by the same reference numerals, and a detailed description thereof will be omitted.

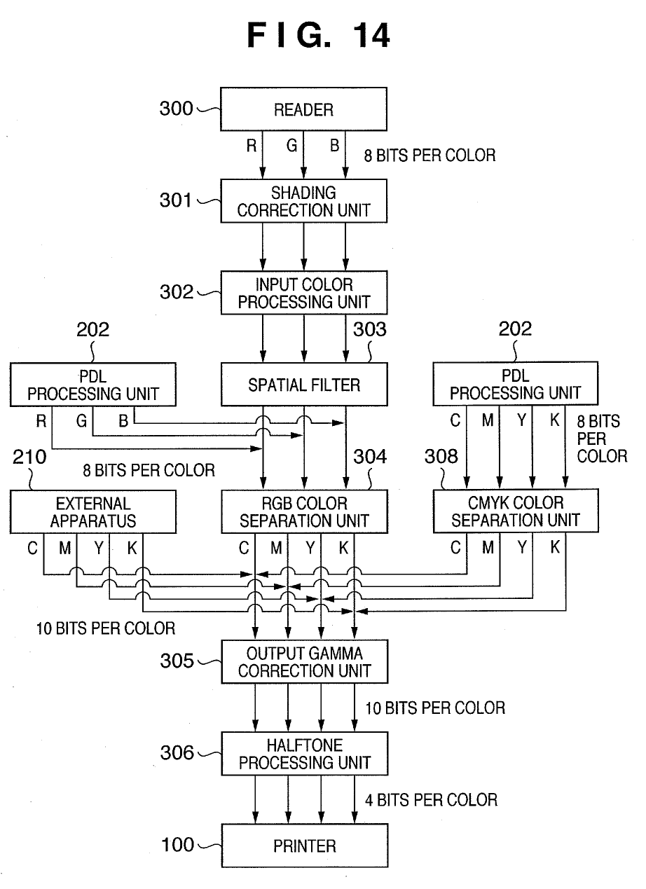

FIG. 14 is a block diagram showing the configuration of an image processing unit 207 of an image forming apparatus according to the second embodiment.

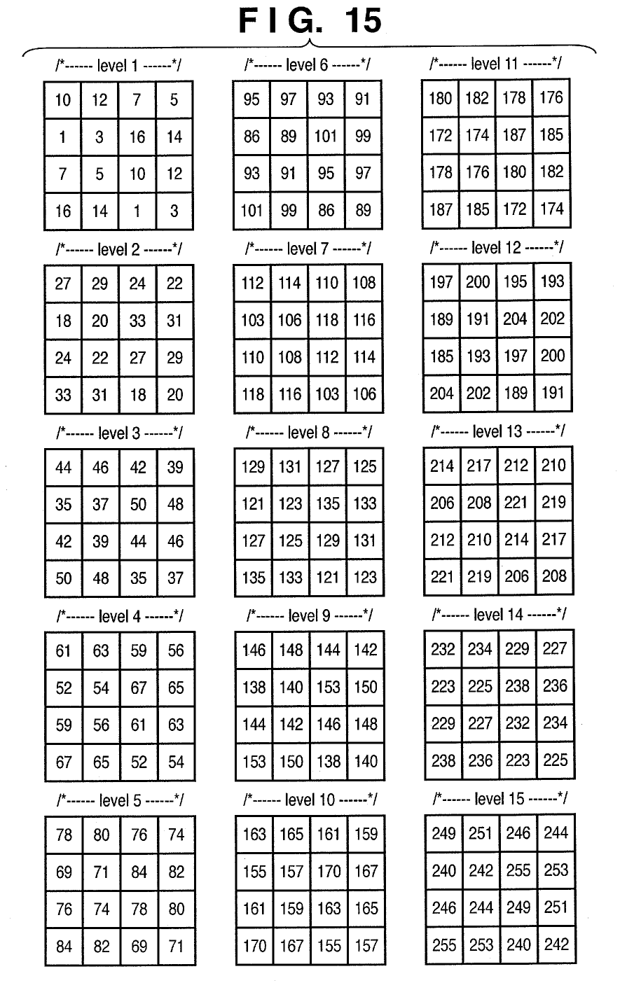

The image forming apparatus of the second embodiment operates as a system using four colors of cyan, magenta, yellow, and block without using light cyan and light magenta. A halftone processing unit 306 performs digital halftoning to yellow having higher lightness than those of the other three colors by using a dither matrix of a “flat” screen having the same screen angle and the same screen rulings as those for black shown in FIG. 15. For cyan, magenta, and black, a “normal” screen as in the first embodiment will be used. That is, the screen angles and the screen ruling of respective colors used in the second embodiment are set as follows:

71° and 189 for cyan;

18° and 189 for magenta; and

45° and 212 for yellow and black.

Note that the dither matrix for yellow is not limited to have the same screen angle and the same screen ruling as those for black, and a “flat” screen having the same screen angle and the same screen ruling as those for the other colors, i.e., cyan and magenta, may be used.

### Third Embodiment

Image processing according to the third embodiment of the present invention will be described below. Note that, in the third embodiment, the same arrangements as in the first embodiment are denoted by the same reference numerals, and a detailed description thereof will be omitted.

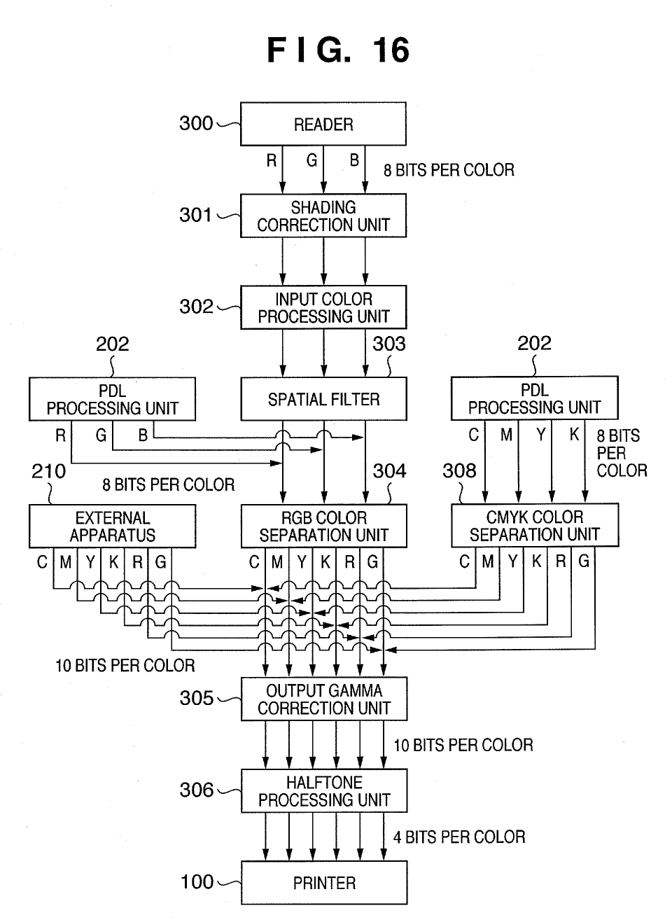

FIG. 16 is a block diagram showing the configuration of an image processing unit 207 of an image forming apparatus according to the third embodiment.

The image forming apparatus of the third embodiment operates as a system using six colors including red (R) and green (G) instead of light cyan and light magenta. An RGB color separation unit 304 separates R, G, and B signals into C, M, Y, and K signals and R and G signals. The CMYK color separation unit 308 separates C, M, Y, and K signals into C, M, Y, and K signals and R and G signals. The halftone processing unit 306 performs digital halftoning to red as a complementary color of cyan by using a dither matrix of a “flat” screen having the same screen angle and the same screen ruling as those for light cyan shown in FIGS. 9A to 9C. The halftone processing unit 306 also performs digital halftoning to green as a complementary color of magenta by using a dither matrix of the “flat” screen having the same screen angle and the same screen ruling as those for light magenta shown in FIGS. 11A to 11C. Note that the same “normal” screens as in the first embodiment are used for cyan, magenta, yellow, and black. That is, the screen angles and the screen ruling of respective colors used in the third embodiment are set as follows:

71° and 189 for cyan and red;

18° and 189 for magenta and green;

0° and 150 for yellow; and

45° and 212 for black.

In the above arrangement, the screen angle and the screen ruling for red are set the same as those for cyan, and those for green are set the same as those for magenta. In addition, a “flat” screen having the same screen angle and the same screen ruling as those for yellow can be applied to blue as a complementary color of yellow.

Modification of Embodiments

In an image forming apparatus having a limited resolution, the screen angle of a dither pattern has a constraint, and generally set to a rotational tangent angle. However, the screen angle can be set to an arbitrary irrational tangent angle by optimizing the lighting position of a laser beam in accordance with the pixel position. In order to ensure the number of tones, a dither matrix can be formed by making a basic cell into a sub matrix.

The screen angle and the screen ruling of the dither matrix for each color in the above embodiments are not limited to those described above.

In the above-described embodiments, a four-color system using basic colors of cyan, magenta, yellow, and black as the colorant configuration, and a six-color system using light cyan and light magenta or red and green in addition to the basic colors are described. However, the present invention can be applied to a system using other plurality of types of colorant. For example, any system can be employed as long as a system which uses a combination of dark and light colorant having the same or similar hue and different lightness values, e.g., a five-color or seven-color system in which light black (i.e., gray) having the same or similar hue as that of black and high lightness is added to the four or six colors.

As described above, when toners of dark and light colors having the same or similar hue are used, dither matrices having the same screen angle, the same screen ruling, and different growing methods are used for the dark and light colors. With this arrangement, generation of moiré and interference fringes can be minimized in a system using five or more colors. In addition, since halftone processing is performed for all colors by dithering, no noise such as error diffusion unique to an FM-screen system is generated. When a dither pattern having a low frequency characteristic is applied to a light color having low lightness to prevent the concentrated growing of dots, the graininess becomes less notable.

In the four-color system using cyan, magenta, yellow, and black, for yellow having high lightness, a dither pattern having the same screen angle and the same screen ruling as those for one of the other three colors and a different growing method is used. With this arrangement, moiré can be reduced more as compared to a four-color system using conventional dithering.

When using the colorant of red, green, and blue each serving as a complementary color of cyan, magenta, and yellow, a dither pattern having the same screen angle and the same screen ruling as those for corresponding complementary color and a different growing method is used. With this arrangement, generation of moiré can be minimized in a system using five or more colors.

### Other Embodiment

The present invention can be applied to a system constituted by a plurality of devices (e.g., host computer, interface, reader, printer) or to an apparatus comprising a single device (e.g., copying machine, facsimile machine).

Further, the object of the present invention can also be achieved by providing a storage medium storing program codes for performing the aforesaid processes to a computer system or apparatus (e.g., a personal computer), reading the program codes, by a CPU or MPU of the computer system or apparatus, from the storage medium, then executing the program.

In this case, the program codes read from the storage medium realize the functions according to the embodiments, and the storage medium storing the program codes constitutes the invention.

Further, the storage medium, such as a floppy disk, a hard disk, an optical disk, a magneto-optical disk, CD-ROM, CD-R, a magnetic tape, a non-volatile type memory card, and ROM can be used for providing the program codes.

Furthermore, besides aforesaid functions according to the above embodiments are realized by executing the program codes which are read by a computer, the present invention includes a case where an OS (operating system) or the like working on the computer performs a part or entire processes in accordance with designations of the program codes and realizes functions according to the above embodiments.

Furthermore, the present invention also includes a case where, after the program codes read from the storage medium are written in a function expansion card which is inserted into the computer or in a memory provided in a function expansion unit which is connected to the computer, CPU or the like contained in the function expansion card or unit performs a part or entire process in accordance with designations of the program codes and realizes functions of the above embodiments.

In a case where the present invention is applied to the aforesaid storage medium, the storage medium stores program codes corresponding to the flowcharts described in the embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-241559, filed Aug. 23, 2005, which is hereby incorporated by reference herein in its entirety.

What is claimed is:

1. An image processing apparatus comprising:
a color separator, arranged to color-separate input image data into image data corresponding to plural colorant; and
a halftone processor, arranged to perform multilevel dither processing for the image data corresponding to the plural colorant, wherein said halftone processor applies dither matrices having the same screen angle, the same screen ruling, and different threshold setting methods to respective image data corresponding to dark colorant and light colorant having the same or similar hue and different lightness values.

2. The apparatus according to claim 1, wherein a dither matrix applied to the dark colorant has a characteristic which concentrates dots of a basic cell.

3. The apparatus according to claim 1, wherein a dither matrix applied to the light colorant has a characteristic which diffuses dots of a basic cell.

4. The apparatus according to claim 1, wherein the dither matrices include matrices equal in number to the number of tones of the image data output from said halftone processor, and the dither matrix for the dark colorant has a characteristic which sets a threshold so as to increase a cell value between cells at identical positions in matrices corresponding to different tone values along with an increase in different tone values, increases a threshold of a cell at a given position, and then increases a threshold of a cell adjacent to the given position.

5. The apparatus according to claim 4, wherein the dither matrix for the light colorant has a characteristic which sets a threshold so as to increase a cell value between cells at identical positions in matrices corresponding to different tone values along with an increase in different tone values, increases a threshold of a cell at a given position, increases a threshold of an adjacent cell adjacent to the given position, and then increases a threshold of a cell adjacent to the adjacent cell.

6. An image processing apparatus comprising:
a color separator, arranged to color-separate input image data into image data corresponding to plural colorant; and
a halftone processor, arranged to perform multilevel dither processing for the image data corresponding to the plural colorant, wherein said halftone processor applies, to image data corresponding to yellow colorant, a dither matrix having the same screen angle and the same screen ruling as those of remaining colorant and a different threshold setting method from those of the remaining colorant.

7. An image processing apparatus comprising:
a color separator, arranged to color-separate input image data into image data corresponding to plural colorant; and
a halftone processor, arranged to perform multilevel dither processing for the image data corresponding to the plural colorant, wherein said halftone processor applies dither matrices having the same screen angle and the same screen ruling and different threshold setting methods to image data corresponding to respective complementary colorant.

8. An image processing method comprising the steps of:
color-separating input image data into image data corresponding to plural colorant; and
performing multilevel dither processing for the image data corresponding to the plural colorant,
wherein in the multilevel dither processing, dither matrices having the same screen angle, the same screen ruling, and different threshold setting methods are applied to respective image data corresponding to dark colorant and light colorant having the same hue and different lightness values.

9. An image processing method comprising the steps of:
color-separating input image data into image data corresponding to plural colorant; and
performing multilevel dither processing for the image data corresponding to the plural colorant, wherein in the multilevel dither processing, a dither matrix having the same screen angle and the same screen ruling as those of remaining colorant and a different threshold setting method from those of the remaining colorant is applied to image data corresponding to yellow colorant.

10. An image processing method comprising the steps of:
color-separating input image data into image data corresponding to plural colorant; and
performing multilevel dither processing for the image data corresponding to the plural colorant,
wherein in the multilevel dither processing, dither matrices having the same screen angle and the same screen ruling and different threshold setting methods are applied to image data corresponding to respective complementary colorant.

11. A computer program product stored on a computer readable medium comprising program code for an image processing method, the method comprising the steps of:
color-separating input image data into image data corresponding to plural colorant; and
performing multilevel dither processing for the image data corresponding to the plural colorant,
wherein in the multilevel dither processing, dither matrices having the same screen angle, the same screen ruling, and different threshold setting methods are applied to respective image data corresponding to dark colorant and light colorant having the same hue and different lightness values.

12. A computer program product stored on a computer readable medium comprising program code for an image processing method, the method comprising the steps of:
color-separating input image data into image data corresponding to plural colorant; and
performing multilevel dither processing for the image data corresponding to the plural colorant,
wherein in the multilevel dither processing, a dither matrix having the same screen angle and the same screen ruling as those of remaining colorant and a different threshold setting method from those of the remaining colorant is applied to image data corresponding to yellow colorant.

13. A computer program product stored on a computer readable medium comprising program code for an image processing method, the method comprising the steps of:
color-separating input image data into image data corresponding to plural colorant; and
performing multilevel dither processing for the image data corresponding to the plural colorant,
wherein in the multilevel dither processing, dither matrices having the same screen angle and the same screen ruling and different threshold setting methods are applied to image data corresponding to respective complementary colorant.
